(19) United States
(12) Patent Application Publication
(10) Pub. No.: US 2015/0017486 A1
(43) Pub. Date: Jan. 15, 2015

(54) MCM-48 TEMPLATED CARBON COMPOSITIONS, ELECTRODES, CELLS, METHODS FOR MAKING AND METHODS FOR USING

(71) Applicant: E I DU PONT DE NEMOURS AND COMPANY, Wilmington, DE (US)

(72) Inventor: Cheng-Yu Lai, West Grove, PA (US)

(73) Assignee: EI DU PONT DE NEMOURS AND COMPANY, Wilmington, DE (US)

(21) Appl. No.: 14/384,726

(22) PCT Filed: Mar. 8, 2013
(86) PCT No.: PCT/US13/29759

§ 371 Date: Sep. 12, 2014

Related U.S. Application Data
(60) Provisional application No. 61/610,644, filed on Mar. 14, 2012.

(51) Int. Cl. H01M 4/36; H01M 4/134; C01B 31/08; H01M 4/38; H01M 4/58; H01M 4/587; H01M 4/133; H01M 4/136

(52) U.S. Cl. CPC H01M 4/364; H01M 4/133; H01M 4/134; H01M 4/136; H01M 4/386; H01M 4/581; H01M 4/587; C01B 31/085; H01M 2004/028
USPC 429/7; 429/50; 423/445 R

(57) ABSTRACT

There is a composition comprising templated carbon. The templated carbon has a carbon microstructure that is complementary with a three-dimensional framework of MCM-48 silica particles used in a process for making the templated carbon. There is also an electrode including a circuit contact and a cathode composition. The cathode composition comprises sulfur compound and templated carbon. The templated carbon in the cathode composition has a carbon microstructure that is complementary with a three-dimensional framework of MCM-48 silica particles used in a process for making the templated carbon.

### CROSS-REFERENCE TO RELATED APPLICATIONS

This application claims priority to and the benefit of the filing date of U.S. Provisional Application No. 61/610,644, filed on Mar. 14, 2012, the entirety of which is herein incorporated by reference.

### BACKGROUND OF THE INVENTION

There is significant interest in lithium sulfur (i.e., “Li—S”) batteries as potential portable power sources for their applicability in different areas. These areas include emerging areas, such as electrically powered automobiles and portable electronic devices, and traditional areas, such as car ignition batteries. Li—S batteries offer great promise in terms of cost, safety and capacity, especially compared with lithium ion battery technologies not based on sulfur. For example, elemental sulfur is often used as a source of electroactive sulfur in a Li—S cell of a Li—S battery. The theoretical charge capacity associated with electroactive sulfur in a Li—S cell based on elemental sulfur is about 1,672 mAh/g S. In comparison, a theoretical charge capacity in a lithium ion battery based on a metal oxide is often less than 250 mAh/g metal oxide. For example, the theoretical charge capacity in a lithium ion battery based on the metal oxide species LiFePO₄ is 176 mAh/g.

A Li—S battery includes one or more electrochemical voltaic Li—S cells which derive electrical energy from chemical reactions occurring in the cells. A cell includes at least one positive electrode. When a new positive electrode is initially incorporated into a Li—S cell, the electrode includes an amount of sulfur compound incorporated within its structure. The sulfur compound includes potentially electroactive sulfur which can be utilized in operating the cell. A negative electrode in a Li—S cell commonly includes lithium metal. In general, the cell includes a cell solution with one or more solvents and electrolytes. The cell also includes one or more porous separators for separating and electrically isolating the positive electrode from the negative electrode, but permitting diffusion to occur between them in the cell solution. Generally, the positive electrode is coupled to at least one negative electrode in the same cell. The coupling is commonly through a conductive metallic circuit.

Li—S cell configurations also include, but are not limited to, those having a negative electrode which initially does not include lithium metal, but includes another material. Examples of these materials are graphite, silicon-alloy and other metal alloys. Other Li—S cell configurations include those with a positive electrode incorporating a lithiated sulfur compound, such as lithium sulfide (i.e., “Li₂S”).

The sulfur chemistry in a Li—S cell involves a related series of sulfur compounds. During a discharge phase in a Li—S cell, lithium is oxidized to form lithium ions. At the same time larger or longer chain sulfur compounds in the cell, such as S₈ and Li₂S₈, are electrochemically reduced and converted to smaller or shorter chain sulfur compounds. In general, the reactions occurring during discharge may be represented by the following theoretical discharging sequence of the electrochemical reduction of elemental sulfur to form lithium polysulfides and lithium sulfide:

S₈→Li₂S₈→Li₂S₆→Li₂S₄→Li₂S₃→Li₂S₂→Li₂S

During a charge phase in a Li—S cell, a reverse process occurs. The lithium ions are drawn out of the cell solution. These ions may be plated out of the solution and back to a metallic lithium negative electrode. The reactions may be represented, generally, by the following theoretical charging sequence representing the electrooxidation of the various sulfides to elemental sulfur:

Li₂S→Li₂S₂→Li₂S₃→Li₂S₄→Li₂S₆→Li₂S₈→S₈

A common limitation of previously-developed Li—S cells and batteries is capacity degradation or capacity “fade”. It is generally believed that capacity fade is due, in part, to sulfur loss through the formation of certain soluble sulfur compounds which “shuttle” between electrodes in a Li—S cell and react to deposit on a surface of a negative electrode forming “anode-deposited” sulfur compounds. It is believed that the anode-deposited sulfur compounds can obstruct and otherwise foul the surface of the negative electrode and may also result in sulfur loss from the total electroactive sulfur in the cell. The formation of anode-deposited sulfur compounds involves complex chemistry which is not completely understood.

Some previously-developed Li—S cells and batteries have utilized high loadings of sulfur compound in their positive electrodes in attempting to address the drawbacks associated with capacity degradation and anode-deposited sulfur compounds. However, simply utilizing a high loading of sulfur compound presents other difficulties, including a lack of adequate containment for the entire amount of sulfur compound in the high loading. Furthermore, the positive electrodes made with these compositions tend to crack or break. Another difficulty might be due, in part, to the insulating effect of the high loading of sulfur compound. This insulating effect may contribute to difficulties in realizing the full capacity associated with all the potentially electroactive sulfur in the high loading in a positive electrode of these previously-developed Li—S cell and batteries.

Conventionally, the lack of adequate containment for a high loading of sulfur compound has been addressed by incorporating a high amount of binder in the positive electrodes of these previously-developed Li—S cell and batteries. However, a positive electrode incorporating a high binder amount tends to have a lower sulfur utilization which, in turn, lowers the effective maximum discharge capacity of the Li—S cells with these electrodes.

Li—S cells and batteries are desirable based on the high theoretical capacities and high theoretical energy densities of the electroactive sulfur in their positive electrodes. However, attaining the full theoretical capacities and energy densities remains elusive. In addition, the concomitant limitations associated with capacity degradation, anode-deposited sulfur compounds and the poor conductivities intrinsic to sulfur compound itself, all of which are associated with previously-developed Li—S cells and batteries, limits the application and commercial acceptance of Li—S batteries as power sources.

Given the foregoing, what is needed are Li—S cells and batteries without the above-identified limitations of previously-developed Li—S cells and batteries.

### BRIEF SUMMARY OF THE INVENTION

This summary is provided to introduce a selection of concepts. These concepts are further described below in the Detailed Description. This summary is not intended to identify key features or essential features of the claimed subject matter. Also, this summary is not intended as an aid in determining the scope of the claimed subject matter.

The present invention meets the above-identified needs by providing “MCM-48 templated carbon” and compositions comprising same. An MCM-48 templated carbon has a carbon microstructure which is related, in a complementary way, to the silica microstructure of the three-dimensional silica framework in a mesoporous MCM-48 silica particle used in making the MCM-48 templated carbon. MCM-48 silica particles used in making MCM-48 templated carbon may have select physical properties. According to an embodiment, the MCM-48 silica particles may be characterized as having select aspects, such as a high surface area, a large pore volume and large dimensions associated with the pore diameter or average pore diameter of pores within the MCM-48 three-dimensional framework. In this embodiment, the select aspects of the MCM-48 silica particles used as template are reflected in a complementary way in the carbon microstructure of the MCM-48 templated carbon.

The MCM-48 templated carbon may host sulfur compound in porous regions of its carbon microstructure. Templated carbon hosting a sulfur compound is a carbon-sulfur (i.e., “C—S”) composite, the MCM-48 templated carbon forming a “MCM-48 C—S composite”. The sulfur compound of the MCM-48 C—S composite is generally located substantially within the carbon microstructure of the MCM-48 templated carbon. Different species of sulfur compound may be utilized. Different amounts of sulfur compound may be utilized as well, such as percentages by weight sulfur compound in the MCM-48 C—S composite. The MCM-48 C—S composite may be utilized as a component of a cathode composition. The cathode composition may also comprise polymeric binder and other components. The cathode composition can be incorporated into positive electrodes of Li—S cells for Li—S batteries.

Li—S cells and batteries comprising MGM-48 C—S composite in a positive electrode, according to the principles of the invention, have high maximum discharge capacities and without the above-identified limitations of previously-developed cells and batteries. While not being bound by any particular theory, it is believed that the MCM-48 templated carbon in MCM-48 C—S composites provide the high maximum discharge capacities in the Li—S cells and batteries. In addition, the Li—S cells and batteries do not demonstrate low sulfur utilization or high discharge capacity degradation.

These and other objects are accomplished by compositions comprising MCM-48 templated carbon, MCM-48 C—S composite in cathode compositions, electrodes, cells, methods for making and methods for using such, in accordance with the principles of the invention.

According to a first principle of the invention, there is a composition comprising templated carbon. The templated carbon has a carbon microstructure that may be complementary with a three-dimensional framework of MCM-48 silica particles used in a process for making the templated carbon. The MCM-48 silica particles may be characterized by having one or more of a surface area of about 300 to 2,000 square meters per gram, a pore volume of about 0.5 to 1.5 cubic centimeters per gram, an average pore diameter dimension of about 1 to 20 nanometers, and an average particle size of about 5 to 2,000 nanometers based on the average diameter of the particles. The MCM-48 silica particles may be characterized by having one or more of the surface area being about 1,000 to 2,000 square meters per gram, the pore volume being about 1 to 1.5 cubic centimeters per grain, and the average pore diameter dimension being about 3 to 20 nanometers. The MCM-48 silica particles may be characterized by having one or more of the surface area being about 1,100 to 2,000 square meters per gram, the pore volume being about 1.1 to 1.5 cubic centimeters per gram, and the average pore diameter dimension being about 3.2 to 20 nanometers. The MCM-48 silica particles may be characterized. by having one or more of the surface area being about 1,200 to 2,000 square meters per gram, the pore volume being about 1.3 to 1.5 cubic centimeters per gram, and the average pore diameter dimension being about 3.5 to 20 nanometers. The MCM-48 silica particles may be spherical. The MCM-48 silica particles may be made by a process utilizing silica precursor and a plurality of surfactants.

According to a second principle of the invention, there is a method for making a composition. The method may comprise one or more of introducing carbon precursor into MCM-48 silica particles, stabilizing carbon from the introduced carbon precursor to form stabilized carbon in proximity with the particles, removing the particles from the stabilized carbon to form a composition. The composition may comprise templated carbon having a carbon microstructure that is complementary with a three-dimensional framework of MCM-48 silica particles used in a process for making the templated carbon. The method may comprise introducing a second carbon precursor to supplement the stabilized carbon.

According to a third principle of the invention, there is an electrode. The electrode may comprise a circuit contact and a composition. The composition may comprise sulfur compound and a templated carbon having a carbon microstructure that is complementary with a three-dimensional framework of MCM-48 silica particles used in a process for making the templated carbon. The MCM-48 silica particles may be characterized by one or more of a surface area of about 300 to 2,000 square meters per gram, a pore volume of about 0.5 to 1.5 cubic centimeters per gram, an average pore diameter dimension of about 1 to 20 nanometers, and an average particle size of about 5 to 2,000 nanometers based on the average diameter of the silica particles. The MCM-48 particles may be characterized by one or more of the surface area being about 1,000 to 2,000 square meters per gram, the pore volume being about 1 to 1.5 cubic centimeters per gram, and the average pore diameter dimension being about 3 to 20 nanometers. The MCM-48 silica particles may be characterized by one or more of at least one of the surface area being about 1,100 to 2,000 square meters per gram, the pore volume being about 1.1 to 1.5 cubic centimeters per gram, and the average pore diameter dimension being about 3.2 to 20 nanometers. The MCM-48 silica particles may be characterized by one or more of the surface area being about 1,200 to 2,000 square meters per gram, the pore volume being about 1.3 to 1.5 cubic centimeters per gram, and the average pore diameter dimension being about 3.5 to 20 nanometers. The MCM-48 silica particles may be spherical. The MCM-48 silica particles may be made by a process utilizing silica precursor and a plurality of surfactants.

According to a fourth principle of the invention, there is a cell. The cell may comprise one or more of a negative electrode, a positive electrode, a circuit coupling the positive electrode and negative electrode and a lithium-containing electrolyte medium. The positive electrode may incorporate a cathode composition comprising sulfur compound and templated carbon having a carbon microstructure that is complementary with a three-dimensional framework of MCM-48 silica particles used in a process for making the templated carbon. The MCM-48 silica particles may be characterized by having a surface area of about 300 to 2,000 square meters per gram, a pore volume of about 0.5 to 1.5 cubic centimeters per gram, an average pore diameter dimension of about 1 to 20 nanometers and an average particle size of about 5 to 2,000 nanometers based on the average diameter of the particles. The MCM-48 particles may be characterized by one or more of the surface area being about 1,000 to 2,000 square meters per gram, the pore volume being about 1 to 1.5 cubic centimeters per gram and the average pore diameter dimension being about 3 to 20 nanometers. The MCM-48 silica particles may be characterized by one or more of the surface area being about 1,100 to 2,000 square meters per gram, the pore volume being about 1,1 to 1.5 cubic centimeters per gram and the average pore diameter dimension being about 3.2 to 20 nanometers. The MCM-48 silica particles may be characterized by one or more of the surface area being about 1,200 to 2,000 square meters per gram, the pore volume being about 1.3 to 1.5 cubic centimeters per gram and the average pore diameter dimension being about 3.5 to 20 nanometers. The MCM-48 particles may be spherical. The MCM-48 silica particles may be made by a process utilizing silica precursor and a plurality of surfactants.

According to a fifth principle of the invention, there is a method for using a cell. The method comprises one or more of converting chemical energy stored in the cell into electrical energy and converting electrical energy into chemical energy stored in the cell. The cell may comprise one or more of a negative electrode, a positive electrode, a circuit coupling the positive electrode and negative electrode and a lithium-containing electrolyte medium. The positive electrode incorporates a cathode composition. The cathode composition may comprise sulfur compound and a templated carbon having a carbon microstructure that is complementary with a three-dimensional framework of MCM-48 silica particles used in a process for making the templated carbon. The cell may be associated with one or more of a portable battery, a power source for an electrified vehicle, a power source for an ignition system of a vehicle and a power source for a mobile device.

The above summary is not intended to describe each embodiment or every implementation of the present invention. Further features, their nature and various advantages will be more apparent from the accompanying drawings and the following detailed description of the examples and embodiments.

### BRIEF DESCRIPTION OF THE DRAWINGS

The features and advantages of the present invention become more apparent from the detailed description set forth below when taken in conjunction with the drawings in which like reference numbers indicate identical or functionally similar elements. Additionally, the left-most digit of a reference number identifies the drawing in which the reference number first appears.

In addition, it should be understood that the drawings in the figures which highlight the aspects, methodology, functionality and advantages of the present invention, are presented for example purposes only. The present invention is sufficiently flexible, such that it may be implemented in ways other than shown in the accompanying figures.

FIG. 1 is a two-dimensional perspective of a Li—S cell containing a positive electrode comprising a MCM-48 C—S composite, according to an example;

FIG. 2 is a flow diagram showing a process for making a Li—S cell containing a positive electrode comprising a MCM-48 C—S composite, according to an example;

FIG. 3 is a schematic of a perspective view of a MCM-48 three-dimensional framework, according to an example; and

FIG. 4 is a context diagram illustrating properties of a Li—S battery or cell containing a positive electrode including a MCM-48 C—S composite, according to an example.

### DETAILED DESCRIPTION

The present invention is useful for certain energy storage applications, and has been found to be particularly advantageous for high maximum discharge capacity batteries utilizing electrochemical voltaic cells which derive electrical energy from chemical reactions involving sulfur compounds. While the present invention is not necessarily limited to such applications, various aspects of the invention are appreciated through a discussion of various examples using this context.

For simplicity and illustrative purposes, the present invention is described by referring mainly to embodiments, principles and examples thereof. In the following description, numerous specific details are set forth in order to provide a thorough understanding of the examples. It is readily apparent however, that the embodiments may be practiced without limitation to these specific details. In other instances, some embodiments have not been described in detail so as not to unnecessarily obscure the description. Furthermore, different embodiments are described below. The embodiments may be used or performed together in different combinations.

The operation and effects of certain embodiments can be more fully appreciated from a series of examples, as described below. The embodiments on which these examples are based are representative only. The selection of those embodiments to illustrate the principles of the invention does not indicate that materials, components, reactants, conditions, techniques, configurations and designs, etc. which are not described in the examples are not suitable for use, or that subject matter not described in the examples is excluded from the scope of the appended claims and their equivalents. The significance of the examples can be better understood by comparing the results obtained therefrom with potential results which can be obtained from tests or trials that may be or may have been designed to serve as controlled experiments and provide a basis for comparison.

As used herein, the terms “based on”, “comprises”, “comprising”, “includes”, “including”,” “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, or refers to an inclusive or and not to an exclusive or. For example, a condition A or B is satisfied by any one of the following: A is true (or present) and B is false (or not present), A is false (or not present) and B is true (or present), and both A and B are true (or present). Also, use of the “a” or an is employed to describe elements and components. This is done merely for convenience and to give a general sense of the description. This description should be read to include one or at least one and the singular also includes the plural unless it is obvious that it is meant otherwise.

As used herein and unless otherwise stated the term “cathode” is used to identify a positive electrode and “anode” to identify the negative electrode of a battery or cell. The term “battery” is used to denote a collection of one or more cells arranged to provide electrical energy. The cells of a battery can be arranged in various configurations (e.g., series, parallel and combinations thereof).

The term “sulfur compound” as used herein refers to any compound that includes at least one sulfur atom, such as elemental sulfur and other sulfur compounds, such as lithiated sulfur compounds including disulfide compounds and polysulfide compounds. For further details on examples of sulfur compounds particularly suited for lithium batteries, reference is made to “A New Entergy Storage Material: Organosulfur Compounds Based on Multiple Sulfur-Sulfur Bonds”, by Naoi et al, J. Electrochem. Soc., Vol. 144, No. 6, pp. L170-L172 (June 1997), which is incorporated herein by reference in its entirety.

The meaning of abbreviations and certain terms used herein is as follows: “A” means angstrom(s), “nm” means nanometer(s), “g” means gram(s), “mg” means milligram(s), means microgram(s), “L” means liter(s), “mL” means milliliter(s), “cc” means cubic centimeter(s), “cc/g” means cubic centimeters per gram, “mol” means mole(s), “mmol” means millimole(s), “M” means molar concentration, “wt. %” means percent by weight, “Hz” means hertz, “mS” means millisiemen(s), “mA” mean milliamp(s), “mAh/g” mean milliamp hour(s) per gram, “mAh/g S” mean milliamp hour(s) per gram sulfur based on the weight of sulfur atoms in a sulfur compound, “V” means volt(s), “x C” refers to a constant current that may fully charge/discharge an electrode in 1/x hours, “SOC” means state of charge, “SEI” means solid electrolyte interface formed on the surface of an electrode material, “kPa” means kilopascal(s), “rpm” means revolutions per minute, “psi” means pounds per square inch, “maximum discharge capacity” is the maximum milliamp hour(s) per gram of a positive electrode in a Li—S cell at the beginning of a discharge phase, “coulombic efficiency” is the fraction or percentage of the electrical charge stored in a rechargeable battery by charging and is recoverable during discharging and is expressed as 100 times the ratio of the charge capacity on discharge to the charge capacity on charging, “pore volume” (i.e., “Vp”) is the sum of the volumes of all the pores in one gram of a substance and may be expressed as cc/g, “porosity” (i.e., “void fraction”) is either the fraction (0-1) or the percentage (0-100%) expressed by the ratio: (volume of voids in a substance)/(total volume of the substance).

According to the principles of the invention, and as demonstrated in the following examples and embodiments, there are MCM-48 templated carbon compositions, MCM-48 C—S composites in cathode compositions, positive electrodes and Li—S cells as well as associated methods for making and methods for using such. The cathode composition may comprise a MCM-48 C—S composite comprising MCM-48 templated carbon with sulfur compound situated within porous regions of the carbon microstructure in the MCM-48 templated carbon. According to various embodiments, the MCM-48 C—S composite may comprise a percentage by weight of sulfur compound in the C—S composite (i.e., “sulfur compound loading”) and be combined with polymeric binder and other components in the cathode composition. A preferred sulfur compound loading is from about 5 to 95 wt. %. A more preferred sulfur compound loading is from about 10 to 88 wt. %. A still more preferred sulfur compound loading is from about 50 to 85 wt. %. Other sulfur compound loadings may also be utilized.

Li—S batteries and cells with positive electrodes comprising MCM-48 C—S composite, according to the principles of the invention, demonstrate high maximum discharge capacities and high sulfur utilization. Without being bound by any particular theory, the high maximum discharge capacities observed on discharge appears to be a direct consequence of including MCM-48 C—S composite in the positive electrode of the Li—S batteries and cells.

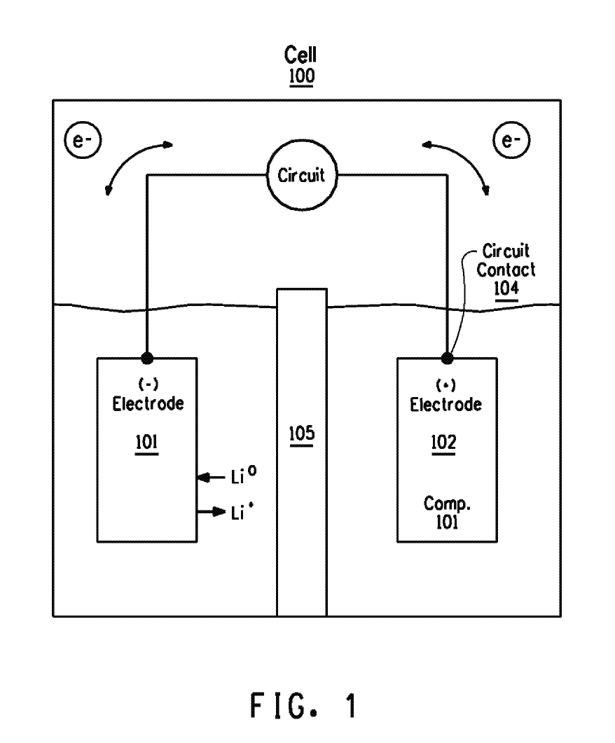

Referring to FIG. 1, depicted is a cell 100 in a Li—S battery, comprising a positive electrode 102 incorporating a cathode composition 103. The cathode composition 103 incorporates a MCM-48 C—S composite comprising MCM-48 templated carbon as a host for sulfur compound. The MCM-48 templated carbon is prepared using mesoporous MCM-48 silica particles as a template. The cell 100 also includes a lithium containing negative electrode 101 and a porous separator 105. The positive electrode 102 includes a circuit contact 104. The circuit contact 104 provides a conductive conduit for the positive electrode 102 to a circuit coupling the negative electrode 101 with the positive electrode 102. The positive electrode 102 is operable in conjunction with the negative electrode 101 in the cell 100 to store and release electrochemical voltaic energy. These electrodes both operate together in converting chemical and electrical energy from one form to the other, depending upon whether the cell 100 is in a charge phase or discharge phase in a charge-discharge cycle.

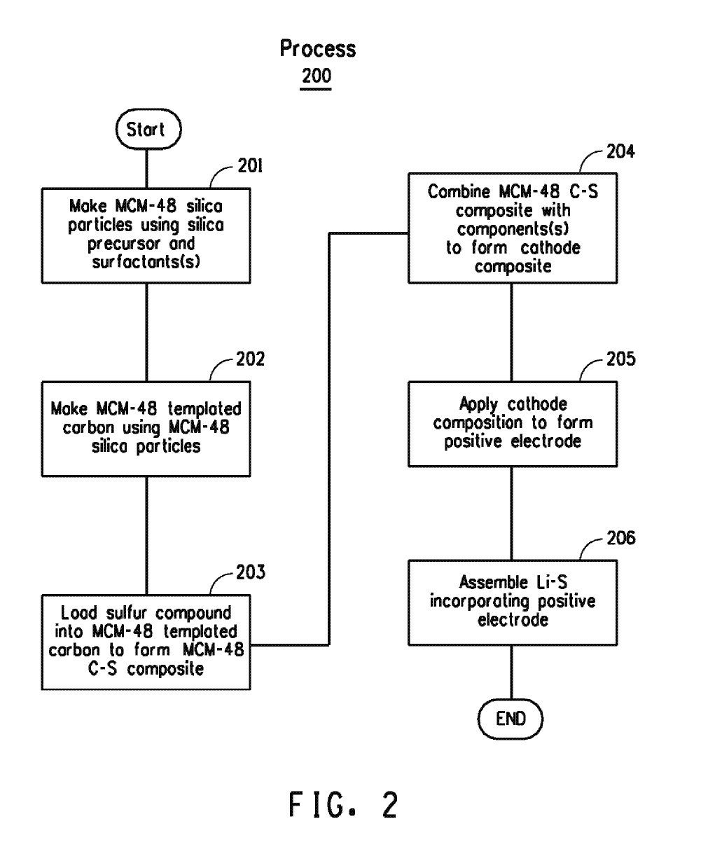

Referring to FIG. 2, depicted is an overview of a process 200 by which a Li—S cell, such as cell 100, is made having MCM-48 C—S composite in the cathode composition 103 of the positive electrode 102. Step 201 is the initial step and directed to the process of making mesoporous MCM-48 silica particles. A particularly useful embodiment is a process for making MCM-48 silica particles having high surface area, large pore volume and large dimensions associated with the pore diameter or average pore diameter of pores within the MCM-48 three-dimensional framework. Step 202 is a process by which MCM-48 templated carbon is made using the MCM-48 silica particles developed in step 201. In step 203, a MCM-48 C—S composite is formed by loading sulfur compound into the MCM-48 templated carbon prepared in step 202. Step 204 is a process of making a cathode composition, such as cathode composition 103, by combining the MCM-48 C—S composite formed in step 203 with other components, such as polymeric binder and carbon black. In step 205, a positive electrode, such as positive electrode 102, is formed by a process of applying the cathode composition made in step 204 by one of various known methods of making electrodes, such as a draw-down method in which the cathode composition is applied to a substrate using a blade. Step 206 is the final step in process 200 and is directed to a process of assembling a Li—S cell, such as cell 100, by installing the positive electrode made in step 205 within a cell assembly along with other cell components as described above with respect to FIG. 1. Embodiments and examples associated with each of the steps in process 200 are described in greater detail below.

MCM-48 templated carbon has a carbon microstructure which is substantially complementary to the three-dimensional framework of the MCM-48 silica, particles used as a template in making the MCM-48 template carbon. Sulfur compound, such as elemental sulfur or lithium sulfide, may be incorporated into the MCM-48 templated carbon so as to be located in the porous regions within the carbon microstructure of the MCM-48 templated carbon. Various processes may be utilized to make the MCM-48 template carbon and to situate sulfur compound within the porous regions to make the C—S composite.

The silica microstructure of the MCM-48 silica particles may be characterized by structural aspects describing the three-dimensional framework in the MCM-48 silica particles, such as pore volume, porosity, three-dimensional framework, wall thickness of the three-dimensional framework, an average wall thickness of the three-dimensional framework, pore diameter, average pore diameter, and dimensions associated with the pore diameter or average pore diameter. The structural aspects characterizing the carbon microstructure of the MCM-48 templated carbon are determined, in part, by the structural aspects of MCM-48 silica particles utilized in making the MCM-48 templated carbon. The carbon microstructure of the MCM-48 templated carbon may also be characterized by one or more structural aspects describing the MCM-48 templated carbon. These include the pore volume, porosity, the three-dimensional carbon framework, the wall thickness of the three-dimensional carbon framework, the average wall thickness of the three-dimensional carbon framework, pore diameter, average pore diameter, and dimensions associated with the pore diameter or the average pore diameter. However, because the carbon microstructure of the MCM-48 templated carbon is complementary to the silica microstructure of the MCM-48 silica particles, certain measures, such as the pore volume and porosity of the carbon microstructure are inversely related to the corresponding measures for the silica microstructure of the MCM-48 silica particles.

In MCM-48 silica particles, the three-dimensional pore system comprises two independent, yet intertwining, channel networks. The pore volumes of these channel networks are inter-connected, and therefore a complement of this framework is in the carbon microstructure of the MCM-48 templated carbon in the C—S composite. The complementary carbon microstructure of the MCM-48 templated carbon is well suited for hosting sulfur compound in a positive electrode of a Li—S cell. According to an embodiment, MCM-48 silica particles having high surface area, large pore volume and large dimensions associated with pore diameter or average pore diameter of pores within the MCM-48 three-dimensional framework may be utilized as a template for making the MCM-48 template carbon. The complementary carbon microstructure, based on a MCM-48 silica template with these properties, is particularly well suited for hosting sulfur compound in a MCM-48 C—S composite for a positive electrode of a Li—S cell.

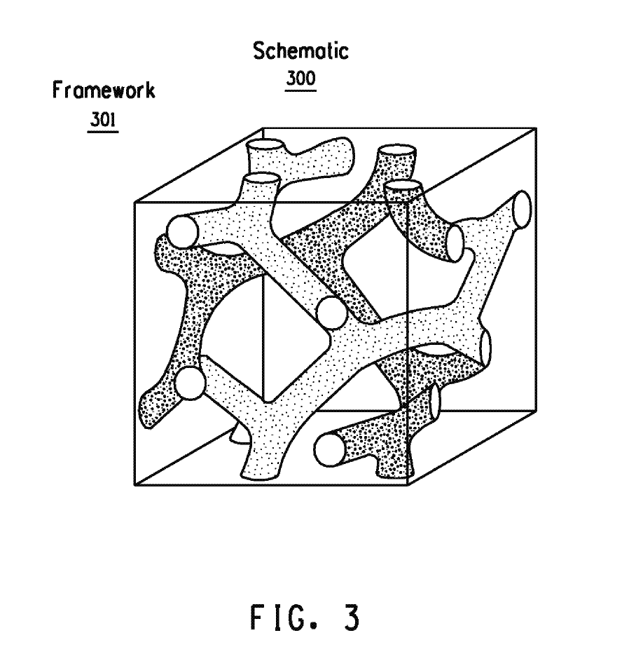

Referring to FIG. 3, depicted is schematic 300 demonstrating a perspective view of a MCM-48 silica three dimensional framework 301. MCM-48 is mesoporous silica having a three-dimensional framework with interconnecting pores and is described in U.S. Pat. No. 5,198,203, incorporated by reference herein in its entirety. MCM-48 is a subset of a family of mesoporous silica materials known by the family designation “M41S”. In addition to MCM-48, other members of the M41S family include MCM-41 and MCM-50. The three-dimensional framework structure associated with the MCM-48 morphology differs from the respective framework structures associated with MCM-41 and MCM-50. MCM-41 has a hexagonal structure with a one-dimensional pore system, while MCM-50 has a lamellar structure. MCM-48 has a cubic Ia3d isometric spacing that forms a symmetrical structure in a three-dimensional pore system like that shown schematically in FIG. 3.

Mesoporous MCM-48 silica particles, such as those having high surface area, large pore volume and large dimensions associated with pore diameter or average pore diameter of pores within the MCM-48 framework, can be synthesized using a variation on the Stöber method via a method using a combination of different types of surfactants under select conditions. The ordinary Stöber method is described in Shimura et al., “Preparation of surfactant templated nanoporous spherical particles by the Stöber method. Effect of solvent composition on the particle size”, J. Mater. Sci., No. 42, pp. 5299-5306 (2007), which is incorporated herein by reference in its entirety. In contrast, MCM-48 silica particles having the desired combination of high surface area, large pore volume and large dimensions associated with pore diameter or average pore diameter, may be prepared from silica precursor in an aqueous solution using a combination of a plurality of different types of surfactants, as described below, under select conditions.

According to an example, two types of surfactants may be used. One type of surfactant is a cationic alkylated primary amine, such as a halogenated alkyl amine. Examples of the cationic surfactant type are hexadecyltrimethylammonium bromide (i.e., CAB), hexadecyltrimethylammonium chloride, tetradecyltrimethylammonium chloride or bromide, and octadecyltrimethylammonium chloride or bromide. Various lengths of the alkyl chain in the cationic surfactant may be employed in the process to vary the properties of the MCM-48 framework in the mesoporous silica particles produced.

A second type of surfactant used in the example method is a non-ionic block alkylene oxide polymer, such as a block copolymer of ethylene oxide and propylene oxide which is hydroxylated. Surfactants of this type are commercially available as PLURONIC® brand surfactants (BASF Chemical Company), such as PLURONIC F-127, Other non-ionic alkylene oxide polymer surfactants may also be used.

One or more silica precursors may be utilized in making the MCM-48 silica particles. A silica precursor is a silicon donating compound which donates silicon to form a silica matrix in the framework structure. Silica precursors suitable for use herein include various alkyl silanes. Examples of these silica precursors include tetraethyl orthosilicate (TEOS), tetramethyl orthositicate (MOS) and octyltrimethoxy silane.

In making the MCM-48 particles, the silica precursor and surfactants can be combined in an aqueous solution to form a mixture. The mixture may also contain one or more additional solvents to facilitate the formation of surfactant micelles or the donation of silicon from the silica precursor. Examples of such additives include alcohols and nitrogen-containing compounds and are well known in the art. The mixture can also be treated so as to facilitate silica matrix formation using vehicles such as agitation, temperature, heat, light, etc, Depending on the additives and vehicles utilized, a period of time from a few minutes to several hours is used to allow formation of the silica particles to occur. After formation, the MCM-48 particles are recovered by separating the surfactant and other components in the solution. Recovery may be performed using well known processes such as separation, washing, drying, etc.

As noted above, according to an embodiment, the MCM-48 silica particles produced using the described process may be characterized as having high surface area, large pore volume and having large dimensions associated with the pore diameter or the average pore diameter of pores within the MCM-48 three-dimensional framework. These physical properties and the MCM-48 framework structure are especially well suited for producing a MCM-48 templated carbon that is particularly useful for hosting sulfur compound in a MCM-48 C—S composite for a positive electrode in a Li—S cell.

MGM-48 silica particles suitable for use herein include those having a surface area of about 100 to 3,000 m²/g silica, about 200 to 2,500 m²/g, about 300 to 2,000 m²/g, about 500 to 2,000 m²/g, about 700 to 2,000 m²/g, about 900 to 2,000 m²/g, about 1000 to 2,000 m²/g, about 1,100 to 2,000 m²/g and about 1,200 to 2,000 m²/g silica. MCM-48 silica particles suitable for use herein include particles having a surface area of about 400 m²/g silica, 600 m²/g, 800 m²/g, 1,000 m²/g, 1,100 m²/g, 1,200 m²/g, 1,300 m² g, 1,400 m²/g, 1,600 m²/g, 1,800 m²/g, 2,000 m²/g, 2,200 m²/g, 2,400 in²/g, 2,600 m²/g, 2,800 m²/g, 3,000 m²/g, and about 3,200 m²/g silica.

MCM-48 silica particles, suitable for use herein include those having a pore volume ranging from about 0.4 to 2 cc/g, silica, from about 0.5 to 1.5 cc/g, from about 0.8 to 1.5 cc/g, from about 1 to 1.5 cc/g, from about 11.1 to 1.5 cc/g, from about 1.2 to 11.5 cc/g, from about 1.3 to 1.5 cc/g, and from about 1.4 to 1.5 cc/g silica. MCM-48 silica particles which are suitable for use herein include particles having a pore volume of about 0.4 cc/g silica, 0.4 cc/g, 0.5 cc/g, 0.6 cc/g, 0.7 cc/g, 0.8 cc/g, 0.9 cc/g, 1.0 cc/g, 1,1 cc/g, 1.2 cc/g, 1.3 cc/g, 1.4 cc/g, 1.5 cc/g, 1.6 cc/g, 1.7 cc/g, 1.8 cc/g, 1.9 cc/g and 2 cc/g silica.

MGM-48 silica particles suitable for use herein may be described in terms of the particle pore diameter(s) of the pores in the MCM-48 three-dimensional framework. The pores may not be uniformly round or uniformly the same size, so the pores may be described as having an average dimension of an average pore diameter (i.e., an average pore diameter dimension). In an instance in which all the pores are substantially round and uniform in size, the average dimension is equivalent to the pore diameter. In an instance in which all the pores are substantially the same size, the average pore diameter is equivalent to the pore diameter. In an instance in which all the pores are substantially the same size and in which all the pores are substantially round and uniform in size, the average pore diameter dimension is equivalent to the pore diameter. MCM-48 silica particles suitable for use herein include those having an average pore diameter dimension of about 1 to 20 or 1 to 30 nanometers. These include particles having an average pore diameter dimension of about 1 nm, 1.5 nm, 2 nm, 2.5 nm, 2.8 nm, 3 nm, 3.1 nm, 3.2 nm, 3.3 rim, 3.5 rim, 3.7 nm, 4 nm, 5 nm, 6 nm, 8 nm, 10 nm, 12 nm, 14 nm, 16 nm, 18 nm, 20 nm, 25 nm and 30 nm.

MCM-48 silica particles suitable for use herein may also described in terms of the average particle size of the MCM-48 silica particles made or utilized in making MCM-48 templated carbon. The particles may be spherical, or have another geometrical configuration, such as ellipsoids, rods, etc. So the particles may be described as having an average particle size based on an average diameter of the particles. MCM-48 silica particles which are suitable for use herein include those having an average particle size based on an average diameter of about 5 to 2,000 nanometers. These include particles having an average particle size based on an average diameter of about 10 nm, 20 nm, 30 nm, 40 nm, 50 nm, 70 nm, 100 nm, 150 nm, 200 nm, 300 nm, 400 nm, 500 nm, 600 nm, 800 nm, 1,000 nm, 1,200 nm, 1,400 nm, 1,600 nm, 1,800 nm, 2,000 nm, 2,500 nm, 3,000 nm, 3,500 nm and 4,000 nm.

The carbon microstructure of an MCM-48 templated carbon may be formed utilizing a carbon precursor. A carbon precursor is any carbon-containing compound or carbonaceous substance which can introduce carbon into porous regions within an inorganic template, such as a MCM-48 silica particle. A carbon precursor may be a polymerizable monomer, oligomer or polymer. A carbon precursor may also be non-polymerizable. A carbon precursor may be in the form of a gas, a liquid or a gel and be a solid which has been solvated, dissolved, solubilized, liquefied, melted and/or vaporized to form a fluid which can be introduced into an inorganic microstructure of an inorganic template.

In an embodiment, a MCM-48 templated carbon is formed by introducing carbon precursor into porous regions of the silica microstructure within a MCM-48 silica particle. With the carbon precursor impregnating the MCM-48 silica three-dimensional framework, the impregnated mass is treated to stabilize the carbon of the carbon precursor within the impregnated porous regions of the MCM-48 silica particle. As the carbon precursor is stabilized, the stabilized carbon is conformed to the silica microstructure within the MCM-48 silica particle. Stabilization may be accomplished through many well-known means including heat, light, chemical treatment, sound, etc. such that the carbon of the carbon precursor is made substantially inert. The stabilization is such that the stabilized carbon is substantially inert to a subsequent removal of the MCM-48 silica template from the stabilized carbon. After the MCM-48 silica template is removed, the remainder is a MCM-48 templated carbon having a carbon microstructure that is complementary, either fully, substantially or in part, with the silica microstructure of the MCM-48 silica template which had been removed.

For example, if the MCM-48 silica template used to make the MCM-48 templated carbon has a silica microstructure with a larger average pore diameter, a larger pore volume or a smaller average wall thickness in the walls of the three-dimensional framework MCM-48 silica particle, a MCM-48 templated carbon formed utilizing the MCM-48 silica template tends to have complementary features, such as a smaller average pore diameter, a smaller pore volume or a larger average wall thickness in the carbon microstructure.

According to an example, a polymerizable carbon precursor, such as an alcohol, may be reacted to form polymerized carbon within the MCM-48 silica template. The polymerizing reaction may be driven, such as by heating, adding a catalyst or other conditions which may be applied utilizing energy to drive the polymerization. Such methods are well-known to those of ordinary skill in the art. The MCM-48 silica template can then be removed from the polymerized carbon by treating the carbon/silica mass to remove the MCM-48 silica. According to an example, the polymerized carbon can first be treated, such as by calcining the carbon/silica mass to decompose the polymerized carbon into a more stable carbon material before applying a treatment, such as by washing with an acid or base, to remove the MCM-48 silica template. A carbon microstructure formed from polymerized carbon can be formed or preserved which is to part or all of the inorganic microstructure of the MCM-48 silica template utilized, by forming the MCM-48 templated carbon from an alcohol carbon precursor. Once the MCM-48 silica template is removed, the remainder, such as a polymerized carbon or a calcined carbon material, is a MCM-48 templated carbon.

Carbon precursors suitable for use herein include, but are not limited to, sucrose, furfuryl alcohol; resorcinol-formaldehyde, pyrrhole, polyaniline, acrylonitrile, vinyl acetate, pyrene and others. These may be used as sources of carbon to form a carbon microstructure based on the inorganic microstructure of a MCM-48 silica template Chemical vapor deposition may optionally be used after the first impregnation and/or stabilization of a first carbon precursor with one of the above or similar carbon sources as a second carbon precursor. One purpose may be to supplement the impregnating first carbon precursor with the aim of making the impregnation into the inorganic template more uniform. According to an example, a carbon containing gas may also be used to introduce a second carbon precursor into the MCM-48 silica template material. Possible carbon containing gases include methane, ethane, propane, butane, ethylene, propylene, acetylene, cyclohexane, and mixtures thereof. Stabilization, such as by polymerization of the carbon precursor may be performed generally by heating and/or other processes. The dissolution of the MCM-48 silica template can be accomplished using acids such as HF or bases such as NaOH, leaving the formed MCM-48 templated carbon.

Sulfur compounds which are suitable for making a MCM-48 C—S composite from the MCM-48 templated carbon include molecular sulfur in its various allotropic forms and combinations thereof, such as “elemental sulfur”. Elemental sulfur is a common name for a combination of sulfur allotropes including puckered S₈ rings, and often including smaller puckered rings of sulfur. Other sulfur compounds which are suitable are compounds containing sulfur and one or more other elements. These include Initiated sulfur compounds, such as for example, Li₂S or Li₂S₂. A representative sulfur compound is elemental sulfur distributed by Sigma Aldrich as “Sulfur”, (Sigma Aldrich, 84683). Other sulfur compound types and sources of such sulfur compounds are known to those having ordinary skill in the art.

A MCM-48 C—S composite may be made by various methods, including mixing; such as by dry grinding, MCM-48 templated carbon with sulfur compound. MCM-48 C—S composite may also be made by introducing sulfur compound into the carbon microstructure of the MCM-48 templated carbon utilizing such vehicles as heat, pressure, liquid (e.g., by dissolution of sulfur compound in carbon disulfide solution and impregnation by contacting the MCM-48 templated carbon with the solution), etc. Other useful methods for introducing sulfur compound into the MCM-48 templated carbon include melt imbibement and vapor imbibement. These are compositing processes for introducing sulfur compound into the carbon microstructure of the MCM-48 templated carbon utilizing such vehicles as heat, pressure, liquid, etc.

In melt imbibement, a sulfur compound, such as elemental sulfur can be heated above its melting point (about, 113° C.) while in contact with MCM-48 templated carbon to impregnate it. The impregnation may be accomplished through a direct process, such as a melt imbibement of elemental sulfur, at a raised temperature, by contacting the sulfur compound and MCM-48 templated carbon at a temperature above 100° C., such as 160° C. A useful temperature range is 120° C. to 170° C. Another imbibement process which may be used for making MCM-48 C—S composite is vapor imbibement which involves the deposition of sulfur vapor. The sulfur compound may be raised to a temperature above 200° C., such as 300° C. At this temperature, the sulfur compound is vaporized and placed in proximity to, but not necessarily in direct contact with, the MCM-48 templated carbon.

These processes may be combined. For example, melt imbibement process can be followed by a higher temperature process. Alternatively, the sulfur compound can be dissolved in carbon disulfide to form a solution and the MCM-48 C—S composite can be formed by contacting this solution with the MCM-48 templated carbon. The MCM-48 C—S composite may also be prepared by dissolving sulfur compound in non-polar solvent, such as toluene or carbon disulfide, and contacting this solution with MCM-48 templated carbon. The solution or dispersion can be contacted, optionally, at incipient wetness to promote an even deposition of the sulfide compound into the pores of the MCM-48 templated carbon. Incipient wetness is a process in which the total liquid volume exposed to the templated carbon does not exceed the volume of the pores of the porous carbon material. The contacting process can involve sequential contacting and drying steps to increase the weight % loading of the sulfur compound. Sulfur compound may also be introduced into the MCM-48 templated carbon by other methods. For example, sodium sulfide (Na₂S) can be dissolved in an aqueous solution to form sodium polysulfide. The sodium polysulfide can be acidified to precipitate the sulfur compound in a MCM-48 templated carbon to form a MCM-48 C—S composite. In this process, the MCM-48 C—S composite may require thorough washing to remove salt byproducts.

Suitable introducing methods include melt imbibement and vapor imbibement. One method of melt imbibement includes heating elemental sulfur (Li₂S will not melt under these conditions) and MCM-48 templated carbon at about 120° C. to about 170° C. in an inert gas, such as nitrogen. A vapor imbibement method may also be utilized. In the vapor imbibement method, sulfur vapor may be generated by heating a sulfur compound, such as elemental sulfur, to between the temperatures of about 120 ° C. and 400° C. for a period of time, such as about 6 to 72 hours in the presence of MCM-48 templated carbon.

MCM-48 C—S composite includes MCM-48 templated carbon containing sulfur compound situated in its carbon microstructure, The amount of sulfur compound which may be contained in the MCM-48 C—S composite is dependent, in part, on the pore volume of the MCM-48 templated carbon. Accordingly, as the pore volume of the MCM-48 templated carbon increases, higher sulfur compound loading with more sulfur compound is possible. Thus, a sulfur compound loading of, for example, about 5 wt. % sulfur compound, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 85 wt. %, 90 wt. % or 95 wt. % sulfur compound may be used.

The cathode composition 103 may be made by combining MCM-48 C—S composite with polymeric binder and other components including carbon black. The cathode composition 103 may include various weight percentages of MCM-48 C—S composite and/or polymeric binder and optionally may include carbon black in addition to the MCM-48 C—S composite and polymeric binder.

A polymeric binder which may be utilized for making the cathode composition 103 includes polymers exhibiting chemical resistance, heat resistance as well as binding properties, such as polymers based on alkylenes, oxides and/or fluoropolymers. Examples of these polymers include polyethylene oxide (PEO), polyisobutylene (PIB), and polyvinylidene fluoride (PVDF). A representative polymeric binder is polyethylene oxide (PEO) with an average M_{w} of 600,000 distributed by Sigma Aldrich as “Poly(ethylene oxide)”, (Sigma Aldrich, 182028). Another representative polymeric binder is polyisobutylene (PIB) with an average M_{w} of 4,200,000 distributed by Sigma Aldrich as “Poly(isobutylene)”, (Sigma Aldrich, 181498). Polymeric binders which are suitable for use herein are also described in U.S. Published Patent Application No. US2010/0068622, which is incorporated by reference herein in its entirety. Other sources of polymeric binders are known to those having ordinary skill in the art.

Carbon blacks which are suitable to be used for making the cathode composition 103 include carbon substances exhibiting electrical conductivity and generally having a lower surface area and lower pore volume relative to the MCM-48 templated carbon described above. Carbon blacks typically are colloidal particles of elemental carbon produced through incomplete combustion or thermal decomposition of gaseous or liquid hydrocarbons under controlled conditions. Other conductive carbons which are also suitable are based on graphite. Suitable carbon blacks include acetylene carbon blacks which are preferred.

A representative carbon black is SUPER C65 distributed by Timcal Ltd. and having BET nitrogen surface area of 62 m²/g carbon black measured by ASTM D3037-89. Other commercial sources of carbon black, and methods of manufacturing or synthesizing them, are known to those of ordinary skill in the art. Carbon blacks which are suitable for use herein include those having a surface area ranging from about 10 to 250 square meters per gram carbon black, about 30 to 200 square meters per gram, about 40 to 150 square meters per gram, about 50 to 100 square meters per gram and about 60 to 80 square meters per gram carbon black.

The MCM-48 C—S composite is generally present in the cathode composition 103 in an amount which is greater than 50 percent by weight of the cathode composition 103. Higher loading with more MCM-48 C—S composite is possible and may be preferred. Thus, a MCM-48 C—S composite loading of, for example, about 55 wt. %, 60 wt. %, 65 wt. %, 70 wt. %, 75 wt. %, 80 wt. %, 82.5 wt. %, 85 wt. %, 82.5 wt. %, 90 wt. %, 91 wt. %, 92 wt. %, 93 wt. %, 94 wt. %, 95 wt. %, 98 wt. %, or 99 wt. % MCM-48 C—S composite may be used. According to an embodiment, about 50 to 99 wt. % MCM-48 C—S composite may be used. In another embodiment, about 70 to 95 wt. % MCM-48 C—S composite may be used. In addition, the MCM-48 composite may be combined with other C—S composites comprising porous carbon not based on a MCM-48 silica template for a combined C—S composite amount, preferably within the parameters described above.

A polymeric binder is generally present in the cathode composition 103 in an amount which is greater than 1 percent by weight of the cathode composition 103. Higher loading with more polymeric binder is possible. Thus, a polymeric binder loading of, for example, about 2 wt. % polymeric binder, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 16 wt. %, or 17.5 wt. % polymeric binder may be used. According to an embodiment, about 1 to 17.5 wt. % polymeric binder may be used. In another embodiment, about 4 to 12 wt. % polymeric binder may be used.

According to an embodiment, carbon black may be present in the cathode composition 103 in an amount which is greater than about 0.01 percent by weight of the cathode composition 103. Higher loading with more carbon black is possible and may be preferred. Thus, a carbon black loading of, for example, about 0.1 wt. % carbon black, 1 wt. %, 2 wt. %, 3 wt. %, 4 wt. %, 5 wt. %, 6 wt. %, 8 wt. %, 10 wt. %, 12 wt. %, 14 wt. %, 15 wt. %, or 20 wt. % carbon black may be used. According to an embodiment, about 0.01 to 15 wt. % carbon black may be used. In another embodiment, about 5 to 10 wt. % carbon black may be used.

According to an embodiment, the cathode composition 103 may be made by combining a MCM-48 C—S composite formed by a compositing process with a polymeric binder, and optionally a carbon black by conventional mixing or grinding processes. A solvent, preferably an organic solvent, such as toluene, alcohol, or n-methylpyrrolidone (NMP), can optionally be utilized depending on the polymeric binder system. The solvent should preferably not react with the polymeric binder to break it down, or significantly alter it.

Also, a porogen (i.e., a void or pore generator) may be included in the cathode composition 103 which is formed into positive electrode 102. A porogen is any additive which can be removed by a chemical or thermal process so as to leave behind a void, changing the pore structure of the formed electrode. The control this provides in the level of porosity in the electrode can be utilized, for example, to manage mass transfer in an electrode. A porogen, such as a carbonate, such as calcium carbonate powder, may be added to a cathode composition including MCM-48 C—S composite, polymeric binder and a conductive carbon black. The cathode composition can be applied onto an aluminum foil current collector to form an electrode. It may be desirable to add the porogen in higher concentrations closer to the current collector. This can create a gradient in the direction of the thickness of the electrode. Once the porogen is in place in the formed electrode, it can then be removed by washing the electrode with dilute acid to leave a void or pore. The type of poragen used and the amount of porogen can be varied to control the porosity of the electrode.

Referring again to FIG. 1, depicted is positive electrode 102 that is made incorporating a cathode composition 103 as described above. The positive electrode 102 may be utilized in the cell 100 in conjunction with a negative electrode, such as a lithium-containing negative electrode 101. According to different embodiments, the negative electrode 101 may contain lithium or a lithium alloy. In another embodiment, the negative electrode 101 may contain graphite or some other non-lithium material. According to the latter embodiment, the positive electrode 102 may be formed to include some form of lithium, such as lithium sulfide (Li₂S). In this embodiment, the MCM-48 C—S composite may be lithiated utilizing lithium sulfide which is incorporated into the MCM-48 templated carbon.

A porous separator, such as porous separator 105, may be constructed from, for example, porous laminates made from polymers such as polyvinylidene fluoride (PVDF), polyvinylidene fluoride co-hexafluoropropylene (PVDF-HFP), polyethylene (PE), polypropylene (PP). Positive electrode 102, negative electrode 101 and porous separator 105 are in contact with a lithium ion-containing electrolyte medium, such as a cell solution containing solvent and electrolyte. In this embodiment, the lithium-containing electrolyte medium is a liquid containing lithium ion electrolyte. In another embodiment, the lithium-containing electrolyte medium may be a solid. In yet another embodiment, the lithium-containing electrolyte medium may be a gel.

The lithium ion electrolyte may be non-carbon-containing. For example, the lithium ion electrolyte may be a lithium salt of such counter ions as hexachlorophosphate (PF₆⁻), perchlorate, chlorate, chlorite, perbromate, bromate, bromite, periodiate, iodate, aluminum fluorides (e.g., AlF₄⁻), aluminum chlorides (e.g., Al₂Cl₇⁻, and AlCl₄⁻), aluminum bromides (e.g., AlBr₄⁻), nitrate, nitrite, sulfate, sulfites, permanganate, ruthenate, perruthenate and the polyoxometallates.

In another embodiment, the lithium ion electrolyte may be carbon containing. For example, the lithium ion salt may contain organic counter ions such as carbonate, the carboxylates (e.g., formate, acetate, propionate, butyrate, valerate, lactacte, pyruvate, oxalate, malonate, glutarate, adipate, deconoate and the like), the sulfonates (e.g., CH₃SO₃⁻, CH₃CH₂SO₃⁻, CH₃(CH₂)₂SO₃⁻, benzene sulfonate, toluenesulfonate, dodecylbenzene sulfonate and the like. The organic counter ion may include fluorine atoms. For example, the lithium ion electrolyte may be a lithium ion salt of such counter anions as the fluorosulfonates (e.g., CF₃SO₃⁻, CF₃CF₂SO₃, CF₃(CF₂)₂ SO₃⁻, CHF₂CF₂SO₃⁻), the fluoroalkoxides (e.g., CF₃O⁻, CF₃CH₂O⁻, CF₃CF₂O⁻ and pentafluorophenolate), the fluoro carboxylates trifluoroacetate and pentafluoropropionate) and fluorosulfonimides (e.g., (CF₃SO₂)₂N⁻). Other electrolytes which are suitable for use herein are disclosed in U.S. Published Patent Applications 2010/0035162 and 2011/00052998 both of which are incorporated herein by reference in their entireties.

The electrolyte medium may exclude a protic solvent since protic liquids are generally reactive with the lithium anode. Solvents are preferable which may dissolve the electrolyte salt. For instance, the solvent may include an organic solvent such as polycarbonate, ether or mixtures thereof. In other embodiments, the electrolyte medium may include a non-polar liquid. Some examples of non-polar liquids include the liquid hydrocarbons, such as pentane, hexane and the like.

Electrolyte preparations suitable for use in the cell solution may include one or more electrolyte salts in a nonaqueous electrolyte composition. Suitable electrolyte salts include without limitation: lithium hexafluorophosphate, Li PF₃(CF₂CF₃)₃, lithium bis(trifluoromethanesulfonyl)imide, lithium his (perfluoroethanesulfonyl)imide, lithium (fluorosulfonyl) (nonafluoro-butanesulfonyl)imide, lithium bis(fluorosulfonyl)imide, lithium tetrafluoroborate, lithium perchlorate, lithium hexafluoroarsenate, lithium trifluoromethanesulfonate, lithium tris (trifluoromethanesulfonyl)methide, lithium bis(oxalato)borate, lithium difluoro(oxalato)borate, Li₂B₁₂F₁₂₋ₓHₓ where x is equal to 0 to 8, and mixtures of lithium fluoride and anion receptors such as B(OC₆F₅)₃. Mixtures of two or more of these or comparable electrolyte salts may also be used. In an embodiment, the electrolyte salt is lithium bis(trifluoromethanesulfonyl)imide. The electrolyte salt may be present in the nonaqueous electrolyte composition in an amount of about 0.2 to about 2.0 M, more particularly about 0.3 to about 1.5 M, and more particularly about 0.5 to about 1.2 M.

### EXAMPLE 1

Example 1 describes the preparation of MCM-48 silica particles having a large surface area, a large pore volume and a large average pore diameter dimension using a double surfactant variation on the Stöber method.

### Preparation of MCM-48 Silica Particles

Approximately 1.0 g of cetyltrimethylammonium bromide (CTAB) surfactant and 4.0 g alkylene oxide triblock copolymer (PLURONIC F127) surfactant were mixed in 350 mL of an aqueous solution including 225 mL water, 25 mL ammonium and 100 mL ethyl alcohol. 4 g of tetraethylorthosilicate (TEOS) was added to the solution at room temperature. After vigorous stirring for 80 seconds, the entire mixture was kept under static conditions for 20 hours at room temperature to allow for complete condensation of the silica. The resulting solid silica product was collected, washed extensively with water and then dried at 80° C. in air. The solid silica product was then calcined for 6 hours at 550 hour ° C. in air to remove any remaining surfactant. The resulting silica particles where spherical in shape and had a MCM-48 three-dimensional framework with a surface area of greater than 1,000 m²/g, a pore volume of 1-2 to cc/g and a pore diameter of 3-4 nm.

### EXAMPLE 2

Example 2 describes the preparation of MCM-48 templated carbon using MCM-48 silica particles prepared in Example 1.

### Preparation of MCM-48 Templated Carbon

Sucrose (1.25 g) was dissolved in 5.0 mL of water containing 0.14 g H₂SO₄. Surfactant free spherical MCM-48 silica particles prepared in Example 1 (1.0 g) were dispersed in the solution and the mixture was sonicated for 1 hour; heated at 100° C. for 12 hours and at 160° C. for another 12 hours. The sucrose impregnation process was repeated once with 5.0 mL of a second aqueous solution containing 0.8 g sucrose and 0.09 g H₂SO₄. The impregnated mass was completely carbonized at 900° C. for 5 hours in an argon atmosphere. To remove the MCM-48 silica template, the impregnated mass was stirred in concentrated NaOH solution to dissolve the silica, resulting in MCM-48 templated carbon.

### EXAMPLE 3

Example 3 describes the preparation of MCM-48 C—S composite using the MCM-48 templated carbon prepared in Example 2.

### Preparation of MCM-48 C—S Composite

To prepare the MCM-48 C—S composite, amounts of the MCM-48 templated carbon prepared in Example 2 was mixed with elemental sulfur according to the following weight mixing ratios: 20%, 35%, 50%, 70% and 80%. Each mixture was held at 150 degree ° C. for 6 hours to allow the melted elemental sulfur to infiltrate into the pores of the MCM-48 templated carbon. The temperature was then increased to and held at 300° C. for 3 hours, According to x-ray diffraction analysis, the materials that were mixed with elemental sulfur at ratios above 50% showed a large amount of crystalline sulfur on the external surface of the material rather than in the pores. A thermogravimetric analysis (TGA) of the MCM-48 C—S composite material obtained at the 50% mixing ratio showed that 28.73% of elemental sulfur was encapsulated inside the pores of the MCM-48 templated carbon.

### EXAMPLE 4

Example 4 describes the preparation of an electrode using the MCM-48 C—S composite prepared in Example 3.

Electrodes were prepared using a mixture of 80 wt. % of the MCM-48 C—S composite prepared in Example 3, 10 wt. % of polyvinylidenefluoride (PVDF, KYNAR761) and 10 wt. % of commercially available carbon black (SUPER-P, Timcal Ltd.). N-methyl-2-pyrrolidone (NMP) was used as a dispersant to make slurry of the mixture. The obtained slurry was then pressed onto an aluminum current collector to form a positive electrode.

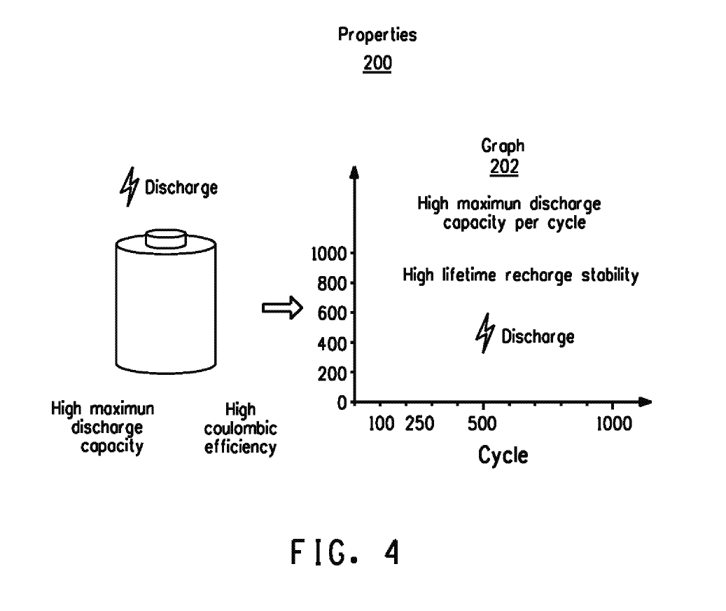

Referring to FIG. 4, depicted is a context diagram illustrating properties 400 of a Li—S battery 401 including a cell, such as cell 100, having a positive electrode, such as positive electrode 102, incorporating a cathode composition, such as cathode composition 103 comprising a MCM-48 C—S composite, according to the principles of the invention. The context diagram of FIG. 4 demonstrates properties 400 of the Li—S battery 401, having a high maximum discharge capacity associated with its discharge. FIG. 4 also depicts a graph 402 demonstrating maximum discharge capacity per cycle with respect to a number of charge-discharge cycles of the Li—S battery 401. The Li—S battery 401 also exhibits high lifetime recharge stability and a high maximum discharge capacity per charge-discharge cycle.

Li—S batteries and cells incorporating MCM-48 C—S composite in a positive electrode, according to the principles of the invention, provides a high maximum discharge capacity Li—S battery or cell. Li—S batteries and cells incorporating cathode compositions with MCM-48 C—S composite may be utilized in a broad range of Li—S battery applications in providing a source of power for many household and industrial applications. Li—S batteries incorporating the cathode compositions comprising MCM-48 C—S composite are especially useful as power sources for small electrical devices such as cellular phones, cameras and portable computing devices and may also be used as power sources for car ignition batteries and for electrified cars.

Although described specifically throughout the entirety of the disclosure, the representative examples have utility over a wide range of applications, and the above discussion is not intended and should not be construed to be limiting. The terms, descriptions and figures used herein are set forth by way of illustration only and are not meant as limitations. Those skilled in the an recognize that many variations are possible within the spirit and scope of the principles of the invention. While the examples have been described with reference to the figures, those skilled in the art are able to make various modifications to the described examples without departing from the scope of the following claims, and their equivalents.

Further, the purpose of the foregoing Abstract is to enable the U.S. Patent and Trademark Office and the public generally and especially the scientists, engineers and practitioners in the relevant art who are not familiar with patent or legal terms or phraseology, to determine quickly from a cursory inspection the nature and essence of this technical disclosure. The Abstract is not intended to be limiting as to the scope of the present invention in any way.

1-7. (canceled)

8. A method for making a composition, comprising:
introducing carbon precursor into MCM-48 silica particles;
stabilizing carbon from the introduced carbon precursor to form stabilized carbon in proximity with the particles;
removing the particles from the stabilized carbon to form a composition comprising
templated carbon having a carbon microstructure that is complementary with a three-dimensional framework of MCM-48 silica particles used in a process for making the templated carbon.

9. The method of claim 8, further comprising
introducing a second carbon precursor to supplement the stabilized carbon.

10-16. (canceled)

17. A cell comprising
a negative electrode,
a positive electrode,
a circuit coupling the positive electrode and negative electrode, and
a lithium-containing electrolyte medium,
wherein the positive electrode incorporates a cathode composition, the cathode composition comprising templated carbon having a carbon microstructure that is complementary with a three-dimensional framework of MCM-48 silica particles used in a process for making the templated carbon, and
sulfur compound, wherein the sulfur compound is elemental sulfur, a lithiated sulfur compound, a disulfide compound, or a polysulfide compound, or a combination thereof.

18. The cell of claim 17, wherein the MCM-48 silica particles are characterized by having
a surface area of about 300 to 2,000 square meters per gram,
a pore volume of about 0.5 to 1.5 cubic centimeters per gram,
an average pore diameter dimension of about 1 to 20 nanometers, and
an average particle size of about 5 to 2,000 nanometers based on the average diameter of the particles.

19. The cell of claim 18, wherein the MCM-48 silica particles are characterized by at least one of
the surface area being about 1,000 to 2,000 square meters per gram,
the pore volume being about 1 to 1.5 cubic centimeters per gram, and
the average pore diameter dimension being about 3 to 20 nanometers.

20. The cell of claim 18, wherein the MCM-48 silica particles are characterized by at least one of
the surface area being about 1,100 to 2,000 square meters per gram,
the pore volume being about 1.1 to 1.5 cubic centimeters per gram, and
the average pore diameter dimension being about 3.2 to 20 nanometers.

21. The cell of claim 18, wherein the MCM-48 silica particles are characterized by at least one of:
the surface area being about 1,200 to 2,000 square meters per gram,
the pore volume being about 1.3 to 1.5 cubic centimeters per gram, and
the average pore diameter dimension being about 3.5 to 20 nanometers.

22. The cell of claim 17, wherein the MCM-48 silica particles are spherical.

23. The cell of claim 17, wherein the MCM-48 silica particles are made by a process utilizing silica precursor and a plurality of surfactants.

24. A method for using a cell, the method comprising at least one of
converting chemical energy stored in the cell into electrical energy; and
converting electrical energy into chemical energy stored in the cell, wherein the cell comprises
a negative electrode,
a positive electrode,
a circuit coupling the positive electrode and negative electrode, and
a lithium-containing electrolyte medium,
wherein the positive electrode incorporates a cathode composition, the cathode composition comprising templated carbon having a carbon microstructure that is complementary with a three-dimensional framework of MCM-48 silica particles used in a process for making the templated carbon, and sulfur compound, wherein the sulfur compound is elemental sulfur, a lithiated sulfur compound, a disulfide compound, or a polysulfide compound, or a combination thereof.

25. The method of claim 24, wherein the cell is associated with at least one of a portable battery, a power source for an electrified vehicle, a power source for an ignition system of a vehicle and a power source for a mobile device.
